(19) United States
(12) Patent Application Publication
(10) Pub. No.: US 2025/0222883 A1
(43) Pub. Date: Jul. 10, 2025

(54) WIRE HARNESS

(71) Applicant: SUMITOMO WIRING SYSTEMS, LTD., Yokkaichi-shi, Mie (JP)

(72) Inventor: Toshiki OMI, Yokkaichi-shi (JP)

(73) Assignee: SUMITOMO WIRING SYSTEMS, LTD, Yokkaichi-shi, Mie (JP)

(21) Appl. No.: 18/852,762

(22) PCT Filed: Mar. 14, 2023
(86) PCT No.: PCT/JP2023/009765

§ 371 Date: Sep. 30, 2024

(30) Foreign Application Priority Data
Mar. 28, 2022 (JP) 2022-051859

(51) Int. Cl. B60R 16/02

(52) U.S. Cl. CPC B60R 16/0215

(57) ABSTRACT

A wire harness for a vehicle, the wire harness including: a wire; and a wire fixing member that includes a holding portion that holds the wire and a fixing portion that is configured to be fixed to a vehicle by fastening a bolt, wherein: the wire has a size of 50 sq or more, the fixing portion includes a tube that is provided inside a through hole extending through the fixing portion, the tube includes: a hard tube portion that includes an insertion hole through which the bolt used for fastening is inserted and has a higher rigidity than the fixing portion; and an elastic portion that has a higher elasticity than the fixing portion, and the elastic portion is located between an outer circumferential surface of the hard tube portion and an inner circumferential surface of the through hole.

### BACKGROUND

The present disclosure relates to a wire harness.

For example, JP 2014-45570A describes a wire harness that includes a wire and a wire fixing member for fixing the wire to a vehicle. The wire fixing member includes a holding portion that holds the wire and a fixing portion that is fixed to the vehicle by fastening a bolt.

### SUMMARY

If a wire included in a wire harness like that described above has a large cross-sectional area to conduct electricity with a high voltage, the wire has a large weight. In such a case, there is a risk that an excessive load will be applied to the fixing portion of the wire fixing member when the vehicle vibrates.

An exemplary aspect of the disclosure provides a wire harness that can reduce a load applied to a fixing portion of a wire fixing member.

A wire harness according to the present disclosure is a wire harness for a vehicle, including: a wire; and a wire fixing member that includes a holding portion that holds the wire and a fixing portion that is configured to be fixed to a vehicle by fastening a bolt, wherein: the wire has a size of 50 sq or more, the fixing portion includes a tube that is provided inside a through hole extending through the fixing portion, the tube includes: a hard tube portion that includes an insertion hole through which the bolt used for fastening is inserted and has a higher rigidity than the fixing portion; and an elastic portion that has a higher elasticity than the fixing portion, and the elastic portion is located between an outer circumferential surface of the hard tube portion and an inner circumferential surface of the through hole.

The wire harness according to the present disclosure has an effect of reducing a load applied to the fixing portion of the wire fixing member.

### BRIEF DESCRIPTION OF THE DRAWINGS

FIG. 1 is a schematic diagram showing a vehicle including a wire harness.

FIG. 2 is a perspective view of a wire harness according to an embodiment.

FIG. 3 is an enlarged plan view showing the vicinity of a fixing portion of a wire fixing member included in the wire harness according to the embodiment.

FIG. 4 is a cross-sectional view taken along a line 4-4 in FIG. 3.

FIG. 5 is a perspective view of a tubular member included in the wire harness according to the embodiment.

FIG. 6 is a cross-sectional view of a wire harness according to a variation.

### DETAILED DESCRIPTION OF EMBODIMENTS

### Description of Embodiments of the Present Disclosure

First, embodiments of the present disclosure will be listed and described.

A wire harness according to the present disclosure is
[1] a wire harness for a vehicle, including: a wire member including a wire; and a wire fixing member including a holding portion that holds the wire member and a fixing portion that is fixed to a vehicle by fastening a bolt, wherein the wire has a size of 50 sq or more, the fixing portion includes a tubular member that is provided inside a through hole extending through the fixing portion, the tubular member includes: a hard tube portion that includes an insertion hole through which the bolt used for fastening is inserted and has a higher rigidity than the fixing portion; and an elastic portion that has a higher elasticity than the fixing portion, and the elastic portion is located between an outer circumferential surface of the hard tube portion and an inner circumferential surface of the through hole.

With this configuration, the hard tube portion of the tubular member can be configured to receive axial force applied from the bolt. Also, transmission of vibration from the vehicle to the fixing portion of the wire fixing member can be suppressed by the elastic portion included in the tubular member. Therefore, it is possible to reduce a load applied to the fixing portion. Accordingly, it is possible to suppress damage on the fixing portion of the wire fixing member holding the wire that has a size of 50 sq or more and is heavy.
[2] The wire member is connected to a motive power device including a travel driving motor.

With this configuration, transmission of vibration from the motive power device, in which the vibration is generated, to the fixing portion of the wire fixing member can be suppressed by the elastic portion of the tubular member.
[3] The wire member electrically connects the motive power device and a battery.

With this configuration, it is possible to reduce a load applied to the fixing portion of the wire fixing member that holds the wire member connecting the motive power device, in which vibration is generated, and the battery, which does not vibrate by its own.
[4] The wire fixing member is disposed inside a compartment that houses a motive power device including a travel driving motor.

In this configuration, the wire fixing member is likely to be more remarkably affected by vibration of the motive power device in which the vibration is generated. Therefore, it is possible to obtain a more remarkable effect of reducing a load applied to the fixing portion with use of the elastic portion.
[5] The wire has a size of 200 sq or less.

In this configuration, it is possible to reduce a load applied to the fixing portion of the wire fixing member holding the wire that has a size of 50 sq or more and 200 sq or less.
[6] The hard tube portion is constituted by a metal, and the elastic portion is constituted by rubber.

With this configuration, axial force applied from the bolt can be received by the hard tube portion constituted by a metal. Also, transmission of vibration from the vehicle to the fixing portion of the wire fixing member can be favorably suppressed by the elastic portion constituted by rubber.
[7] The elastic portion has a tubular shape surrounding the hard tube portion.

With this configuration, transmission of vibration from the vehicle to the fixing portion of the wire fixing member can be favorably suppressed by the tubular elastic portion.
[8] The tubular member includes the hard tube portion as a first hard tube portion, and further includes a second hard tube portion that has a higher rigidity than the elastic portion, and the second hard tube portion is located between the elastic portion and the inner circumferential surface of the through hole.

In this configuration, the second hard tube portion constitutes an outer circumferential surface of the tubular member. Therefore, when compared with a case where the elastic portion constitutes the outer circumferential surface of the tubular member, it is possible to reduce friction when the tubular member is inserted into the through hole of the fixing portion. Consequently, it is possible to improve workability when the tubular member is attached.

### Details of Embodiments of the Present Disclosure

The following describes a specific example of a wire harness according to the present disclosure with reference to the drawings. In the drawings, a portion of a configuration may be exaggerated or simplified for the sake of convenience of description. Also, dimensional ratios between portions may differ between the drawings.

Note that the term “tubular” as used in the description of the present specification means not only the shape of a circumferential wall that is continuously formed over the entire circumference thereof in the circumferential direction but also a tubular shape formed by a plurality of combined parts and a shape in which a portion in the circumferential direction thereof includes a notch or the like, such as a C-shape. Also, “tubular” shapes include circular shapes, elliptical shapes, and polygonal shapes including angular or rounded corners.

### Configuration of Vehicle 10

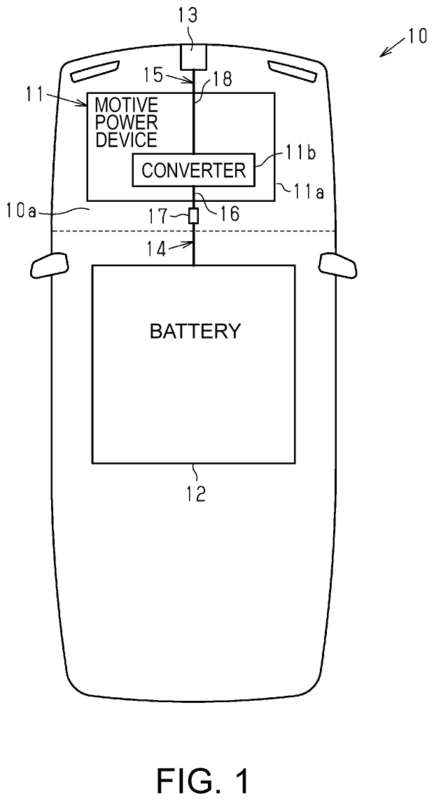

A vehicle 10 shown in FIG. 1 is a hybrid vehicle or an electric vehicle, for example. The vehicle 10 includes a motive power device 11 that generates motive power to cause the vehicle 10 to travel, a battery 12 that supplies electric power to the motive power device 11, and a charging inlet 13.

The motive power device 11 includes a travel driving motor 11a that is a motive power source for causing the vehicle to travel and a converter 11b that is electrically connected to the motor 11a. The converter 11b is an inverter, for example. The converter 11b generates AC power from DC power supplied from the battery 12 and supplies the AC power to the motor 11a. The battery 12 is a high voltage battery that can supply power with a voltage of several hundreds 10 volts, for example. The battery 12 is a secondary battery such as a lithium ion battery, for example. An external power supply device (not shown) can be connected to the charging inlet 13. Power supplied from the external power supply device connected to the charging inlet 13 is supplied to the battery 12 via the motive power device 11 to charge the battery 12.

The motive power device 11 is disposed inside a compartment 10a that is set on the front side of the vehicle 10, for example. In the case where the vehicle 10 is a hybrid vehicle, the compartment 10a is an engine room, for example. The battery 12 is disposed in the vicinity of a position under the floor in a center portion in the front-rear direction of the vehicle 10, for example. The charging inlet 13 is disposed in a front end portion of the vehicle 10, for example.

The vehicle 10 includes a first wire harness 14 electrically connecting the motive power device 11 and the battery 12 and a second wire harness 15 electrically connecting the motive power device 11 and the charging inlet 13.

The first wire harness 14 includes a wire member 16 and a wire fixing member 17 for fixing the wire member 16 to the vehicle 10. One end of the wire member 16 is connected to the converter 11b of the motive power device 11. Another end of the wire member 16 is connected to the battery 12.

The second wire harness 15 includes a wire member 18. One end of the wire member 18 is connected to the converter 11b of the motive power device 11. Another end of the wire member 18 is connected to the charging inlet 13.

### Configuration of First Wire Harness 14

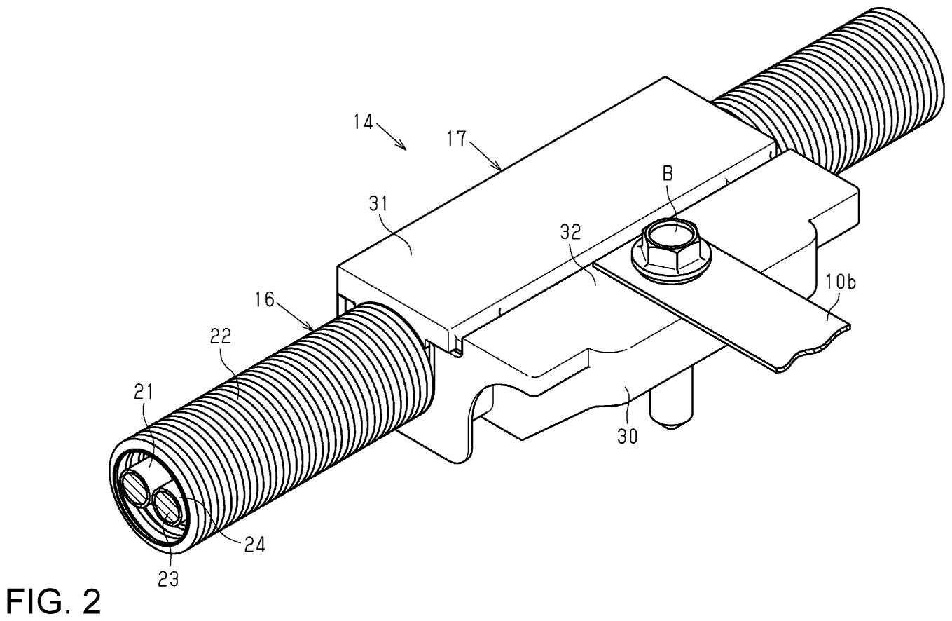

As shown in FIG. 2, the wire member 16 of the first wire harness 14 includes a plurality of wires 21 and an exterior member 22 collectively surrounding the plurality of wires 21, for example. Note that the wire member 18 of the second wire harness 15 also has a configuration substantially the same as the configuration of the wire member 16.

Each wire 21 is a coated wire that includes an electrically conductive core wire 23 and an insulating covering 24 that surrounds an outer circumferential surface of the core wire 23 and has insulating properties. Each wire 21 is a high-voltage wire that can conduct electricity with a high voltage and a large current, for example. The core wire 23 of each wire 21 has a size (a thickness or a cross-sectional area of the conductor) of 50 sq or more and 200 sq or less. The core wire 23 is made of a copper-based or aluminum-based metal material.

The exterior member 22 has a cylindrical shape, for example. Each wire 21 is inserted through the exterior member 22. The exterior member 22 has a function of protecting the wires 21 from flying objects and water drops, for example. The exterior member 22 has flexibility and can be easily bent, for example. Examples of the flexible exterior member 22 include a corrugated tube made of resin and a waterproof cover made of rubber.

The exterior member 22 in the present embodiment is a corrugated tube made of resin and having a bellows shape of which the diameter repeatedly increases and decreases in the length direction of the exterior member 22. That is to say, the exterior member 22 in the present embodiment has a bellows structure in which large-diameter portions and small-diameter portions are alternately connected in the length direction of the exterior member 22. As the material of the exterior member 22, it is possible to use a synthetic resin such as polyolefin, polyamide, polyester, or an ABS resin, for example.

### Configuration of Wire Fixing Member 17

The wire fixing member 17 includes a fixing member body 30. The fixing member body 30 includes a holding portion 31 that holds the wire member 16 and a fixing portion 32 that is fixed to the vehicle 10 by fastening a bolt. The fixing member body 30 is an injection molded article made of a synthetic resin material, for example. As the material of the fixing member body 30, it is possible to use a synthetic resin such as polypropylene or polyamide.

The holding portion 31 holds the exterior member 22 in such a manner as to restrict movement of the exterior member 22 in the length direction and a direction orthogonal to the length direction, for example. The holding portion 31 surrounds an outer circumferential surface of the exterior member 22, for example.

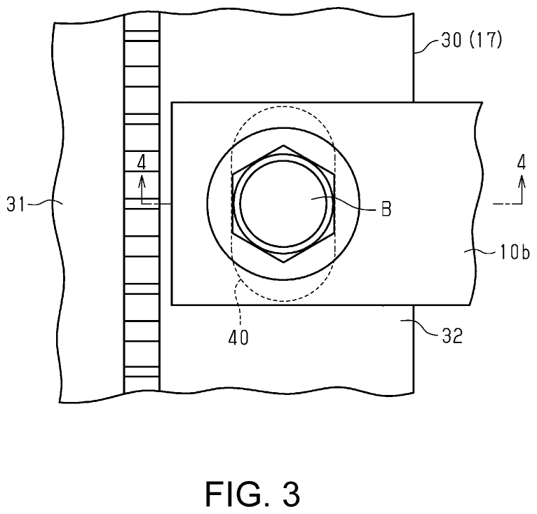

As shown in FIGS. 2 and 3, the fixing portion 32 is fastened to a bracket 10b provided in the vehicle 10 with a bolt B, for example. The bracket 10b is supported by a housing of the motive power device 11, for example.

### Configuration of Fixing Portion 32

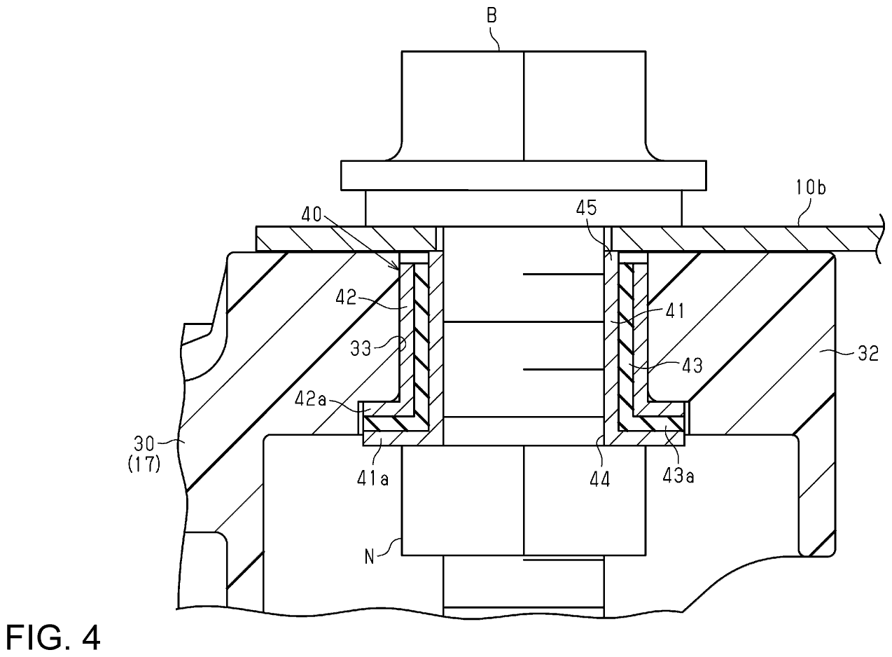

As shown in FIG. 4, the fixing portion 32 includes a tubular member 40 tube) that is provided inside a through hole 33 extending through the fixing portion 32. The tubular member 40 is attached to the insertion hole 33 by being inserted into the through hole 33 formed in the fixing portion 32, for example. Alternatively, the tubular member 40 is partially embedded in a resin portion of the fixing portion 32 through insertion molding or the like, for example.

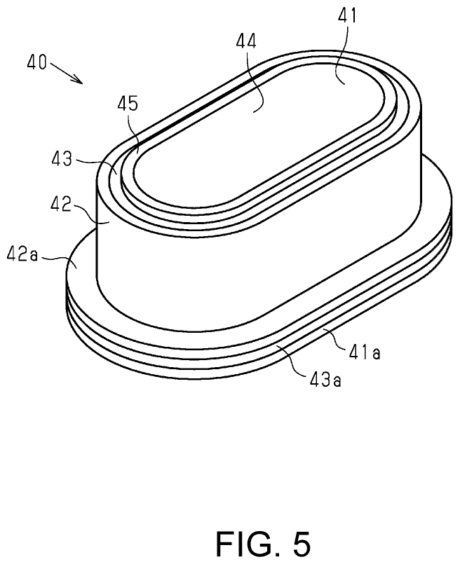

As shown in FIGS. 4 and 5, the tubular member 40 includes a first hard tube portion 41, a second hard tube portion 42, and an elastic portion 43. The tubular member 40 has a structure in which the first hard tube portion 41, the elastic portion 43, and the second hard tube portion 42 are layered in this order from the inner circumferential surface side toward the outer circumferential surface side, for example. That is to say, the elastic portion 43 is located between the first hard tube portion 41 and the second hard tube portion 42. An outer circumferential surface of the second hard tube portion 42 is in contact with an inner circumferential surface of the through hole 33.

The first hard tube portion 41 and the second hard tube portion 42 are made of a material that has a higher rigidity than the synthetic resin constituting the fixing portion 32. As the material of the first hard tube portion 41 and the second hard tube portion 42, it is possible to use an aluminum-based metal or an iron-based metal such as stainless steel, for example. Note that the first hard tube portion 41 and the second hard tube portion 42 may be made of the same material or different materials.

The elastic portion 43 has a tubular shape surrounding an outer circumferential surface of the first hard tube portion 41. The elastic portion 43 is located between the outer circumferential surface of the first hard tube portion 41 and the inner circumferential surface of the through hole 33. Also, an inner circumferential surface of the elastic portion 43 is in contact with the outer circumferential surface of the first hard tube portion 41. An outer circumferential surface of the elastic portion 43 is in contact with an inner circumferential surface of the second hard tube portion 42.

The elastic portion 43 is made of a material that has a higher elasticity than the synthetic resin constituting the fixing portion 32. As the material of the elastic portion 43, it is possible to use silicone rubber, urethane rubber, acrylic rubber, nitrile rubber, butyl rubber, ethylene propylene rubber, or the like.

The first hard tube portion 41 includes an insertion hole 44 through which the bolt B is inserted. The insertion hole 44 has a long hole shape extending in the length direction of the wire member 16, for example. Therefore, it is possible to adjust the position of the wire fixing member 17 in the length direction of the wire member 16.

The first hard tube portion 41 includes a flange portion 41a extending radially outward from an end portion in an axial direction of the tubular member 40. Note that the axial direction of the tubular member 40 coincides with the direction in which the insertion hole 44 extends through the first hard tube portion. The flange portion 41a is provided at an end portion of the first hard tube portion 41 that is opposite to an end portion thereof that is in contact with the bracket 10b, for example.

The elastic portion 43 includes a flange portion 43a extending radially outward from the end portion in the axial direction of the tubular member 40. The flange portion 43a is in contact with the flange portion 41a of the first hard tube portion 41 in the axial direction of the tubular member 40.

The second hard tube portion 42 includes a flange portion 42a extending radially outward from the end portion in the axial direction of the tubular member 40. The flange portion 42a is in contact with the flange portion 43a of the elastic portion 43 in the axial direction of the tubular member 40. The flange portion 43a of the elastic portion 43 is located between the flange portion 41a of the first hard tube portion 41 and the flange portion 42a of the second hard tube portion 42 in the axial direction of the tubular member 40. The flange portion 42a of the second hard tube portion 42 is in contact with the fixing portion 32 in the axial direction of the tubular member 40.

The first hard tube portion 41 includes a protruding portion 45 at the end portion thereof that is opposite to the flange portion 41a. The protruding portion 45 protrudes outward from an end portion of the elastic portion 43 and an end portion of the second hard tube portion 42 in the axial direction of the tubular member 40. The protruding portion 45 is configured to be capable of coming into contact with the bracket 10b in the axial direction of the tubular member 40.

The protruding portion 45 and the flange portion 41a of the first hard tube portion 41 respectively constitute an end portion and another end portion of the tubular member 40 in the axial direction. Therefore, in the state where the fixing portion 32 including the tubular member 40 is fastened to the bracket 10b with the bolt B and a nut N, a head portion of the bolt B is contact with the protruding portion 45 and the nut N is in contact with the flange portion 41a, for example. With this configuration, the first hard tube portion 41 of the tubular member 40 receives axial force applied from the bolt B and the nut N.

The following describes functions of the present embodiment.

For example, vibration generated in the motive power device 11 when the motor 11a is driven is transmitted via the bracket 10b to the tubular member 40 included in the wire fixing member 17. At this time, the vibration transmitted from the bracket 10b to the first hard tube portion 41 is absorbed by the elastic portion 43 provided between the first hard tube portion 41 and the fixing portion 32. Therefore, vibration of the fixing portion 32 and the holding portion 31 is suppressed. When the wires 21 are configured to conduct electricity with a high voltage and accordingly have a large weight, there is a risk that, when the holding portion 31 holding the wire member 16 including the wires 21 vibrates significantly, an excessive load will be applied to the fixing portion 32 fixed to the bracket 10b. However, vibration of the holding portion 31 is suppressed by the elastic portion 43 in the present embodiment, and therefore, a load applied to the fixing portion 32 due to vibration is reduced.

The following describes effects of the present embodiment.
(1) The tubular member 40 includes: the first hard tube portion 41 that includes the insertion hole 44 through which the bolt B used for fastening is inserted and has a higher rigidity than the fixing portion 32; and the elastic portion 43 that has a higher elasticity than the fixing portion 32. The elastic portion 43 is located between the outer circumferential surface of the first hard tube portion 41 and the inner circumferential surface of the through hole 33 in the fixing portion 32.

With this configuration, the first hard tube portion 41 of the tubular member 40 can be configured to receive axial force applied from the bolt B. Also, transmission of vibration from the vehicle 10 to the fixing portion 32 of the wire fixing member 17 can be suppressed by the elastic portion 43 included in the tubular member 40. Therefore, it is possible to reduce a load applied to the fixing portion 32. Accordingly, it is possible to suppress damage on the fixing portion 32 of the wire fixing member 17 holding the wires 21 that have a size of 50 sq or more and are heavy.
(2) The wire member 16 is connected to the motive power device 11 including the travel driving motor 11a. With this configuration, transmission of vibration from the motive power device 11, in which the vibration is generated, to the fixing portion 32 of the wire fixing member 17 can be suppressed by the elastic portion 43 of the tubular member 40.
(3) The wire member 16 electrically connects the motive power device 11 and the battery 12. With this configuration, it is possible to reduce a load applied to the fixing portion 32 of the wire fixing member 17 holding the wire member 16 that connects the motive power device 11, in which vibration is generated, and the battery 12, which does not vibrate by its own.
(4) The wire fixing member 17 is disposed inside the compartment 10a that houses the motive power device 11, and accordingly, the wire fixing member 17 is likely to be more remarkably affected by vibration of the motive power device 11. Therefore, it is possible to obtain a more remarkable effect of reducing a load applied to the fixing portion 32 with use of the elastic portion 43.
(5) Each wire 21 has a size of 200 sq or less. In this configuration, it is possible to reduce a load applied to the fixing portion 32 of the wire fixing member 17 holding the wires 21 that have a size of 50 sq or more and 200 sq or less.
(6) The first hard tube portion 41 is constituted by a metal. Also, the elastic portion 43 is constituted by rubber. With this configuration, axial force applied from the bolt B can be received by the first hard tube portion 41 constituted by a metal. Also, transmission of vibration from the vehicle 10 to the fixing portion 32 of the wire fixing member 17 can be favorably suppressed by the elastic portion 43 constituted by rubber.
(7) The elastic portion 43 has a tubular shape surrounding the first hard tube portion 41. With this configuration, transmission of vibration from the vehicle 10 to the fixing portion 32 of the wire fixing member 17 can be favorably suppressed by the tubular elastic portion 43.
(8) The tubular member 40 includes the second hard tube portion 42 that has a higher rigidity than the elastic portion 43. The second hard tube portion 42 is located between the elastic portion 43 and the inner circumferential surface of the through hole 33. In this configuration, the second hard tube portion 42 constitutes the outer circumferential surface of the tubular member 40. Therefore, when compared with a case where the elastic portion 43 constitutes the outer circumferential surface of the tubular member 40, it is possible to reduce friction when the tubular member 40 is inserted into the through hole 33 of the fixing portion 32. Consequently, it is possible to improve workability when the tubular member 40 is attached.

### Variations

The present embodiment can be implemented with the following changes. The present embodiment and the following variations can be combined as long as no technical contradiction arises.

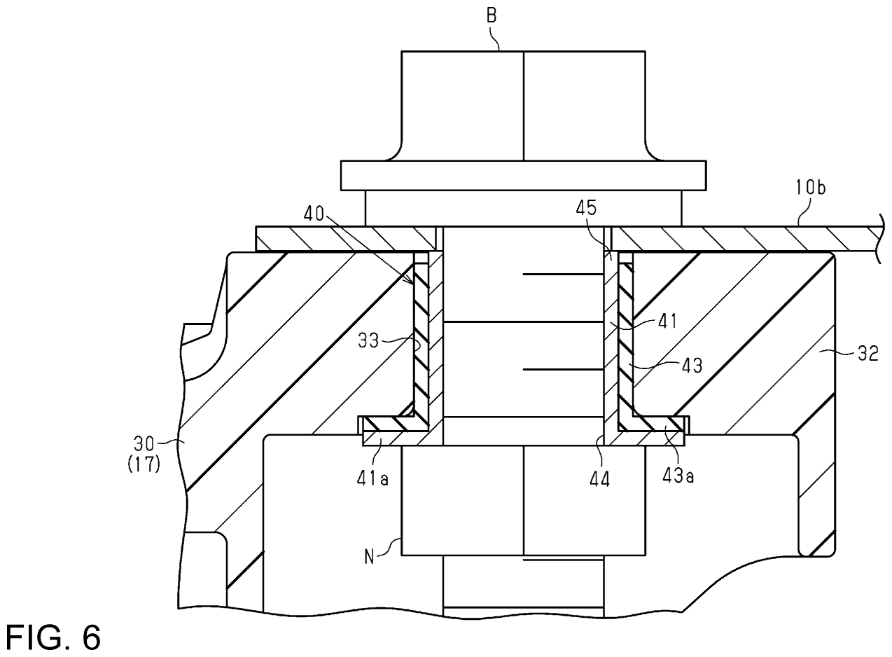

As shown in FIG. 6, the second hard tube portion 42 may be omitted from the tubular member 40 of the above embodiment. In the tubular member 40 shown in FIG. 6, the elastic portion 43 constitutes the outer circumferential surface of the tubular member 40. That is to say, the outer circumferential surface of the elastic portion 43 is in contact with the inner circumferential surface of the through hole 33 of the fixing portion 32. Also, the flange portion 43a of the elastic portion 43 is in contact with the fixing portion 32 in the axial direction of the tubular member 40.

With this configuration as well, a load applied to the fixing portion 32 can be reduced by the elastic portion 43. Also, it is possible to simplify the structure of the tubular member 40 by adopting the tubular member 40 shown in FIG. 6.

The elastic portion 43 is not limited to the configuration in which the elastic portion 43 has a circumferential wall that is continuous along the circumferential direction of the first hard tube portion 41, and a configuration is also possible in which a plurality of elastic portions 43 are provided separately from each other along the circumferential direction of the first hard tube portion 41.

The shape of the tubular member 40 as viewed in the axial direction is not limited to the shape that is long in the length direction of the wire member 16, and can be changed to a circular shape, for example.

The size of the core wire 23 may be larger than 200 sq.

The wire fixing member 17 may be disposed at a position other than the compartment 10a in the vehicle 10.

In the above embodiment, the wire fixing member 17 including the tubular member 40 is used to fix the first wire harness 14 that connects the motive power device 11 and the battery 12. However, there is no limitation to this configuration, and the wire fixing member 17 may also be used to fix the second wire harness 15 that connects the motive power device 11 and the charging inlet 13, for example. Also, the wire fixing member 17 may be used to fix a wire harness other than the first wire harness 14 and the second wire harness 15, which are connected to the motive power device 11. For example, the wire fixing member 17 may also be used to fix a wire harness that directly connects the charging inlet 13 and the battery 12.

In the above embodiment, the present disclosure is applied to the vehicle 10 such as a hybrid vehicle or an electric vehicle including the travel driving motor 11a, but the present disclosure may also be applied to a vehicle that does not include the travel driving motor 11a.

The disclosed embodiment and variations are illustrative examples in all aspects and the present disclosure is not limited to these examples. That is to say, the scope of the present disclosure is defined by the claims and intended to encompass all modifications within the meanings and scope that are equivalent to the claims.

1. A wire harness for a vehicle, the wire harness comprising:
a wire; and
a wire fixing member that includes a holding portion that holds the wire and a fixing portion that is configured to be fixed to a vehicle by fastening a bolt, wherein:
the wire has a size of 50 sq or more,
the fixing portion includes a tube that is provided inside a through hole extending through the fixing portion,
the tube includes: a hard tube portion that includes an insertion hole through which the bolt used for fastening is inserted and has a higher rigidity than the fixing portion; and an elastic portion that has a higher elasticity than the fixing portion, and
the elastic portion is located between an outer circumferential surface of the hard tube portion and an inner circumferential surface of the through hole.

2. The wire harness according to claim 1,
wherein the wire is connected to a motive power device that includes a travel driving motor.

3. The wire harness according to claim 2,
wherein the wire electrically connects the motive power device and a battery.

4. The wire harness according to claim 1,
wherein the wire fixing member is disposed inside a compartment that houses a motive power device that includes a travel driving motor.

5. The wire harness according to claim 1,
wherein the wire has a size of 200 sq or less.

6. The wire harness according to claim 1, wherein:
the hard tube portion is constituted by a metal, and
the elastic portion is constituted by rubber.

7. The wire harness according to claim 1,
wherein the elastic portion has a tubular shape surrounding the hard tube portion.

8. The wire harness according to claim 1, wherein:
the tube includes the hard tube portion as a first hard tube portion, and a second hard tube portion that has a higher rigidity than the elastic portion, and
the second hard tube portion is located between the elastic portion and the inner circumferential surface of the through hole.
